(19) United States
(12) Patent Application Publication
(10) Pub. No.: US 2014/0188747 A1
(43) Pub. Date: Jul. 3, 2014

(54) DETERMINING SHIPPING COSTS USING A LOGISTICS TABLE

(71) Applicant: Chris Andrew D'Urso, Palo Alto, CA (US)

(72) Inventor: Chris Andrew D'Urso, Palo Alto, CA (US)

(73) Assignee: eBay Inc., San Jose, CA (US)

(21) Appl. No.: 13/730,364

(22) Filed: Dec. 28, 2012

(51) Int. Cl. G06Q 10/08

(52) U.S. Cl. CPC G06Q 10/083; G06Q 30/0283
USPC 705/330

(57) ABSTRACT

Example methods and systems to determine shipping costs using a logistics table are described. In some example embodiments, the methods and systems access a base cost associated with shipping an item to a destination at a base level (e.g., at a standard shipping method), select one or more destinations to which to ship the item, and determine shipping costs for every selected destination by inputting the base cost into logistics table. The systems and methods may also display an indication of the determined costs via a user interface, such as via a displayed map or other graphics that present shipping cost information along with destination information.

### TECHNICAL FIELD

This application relates generally to information retrieval, and specifically, to a system and method for determining shipping costs using a logistics table.

### BACKGROUND

General merchandising of items for sale via a network-based merchandising system is well known. Many websites accessible via the Internet are operated as online stores or auctions. These websites enable users to purchase items that may be physical items (e.g., an article of clothing), electronic data items (e.g., a downloadable digital media product), or services to be rendered by an affiliated service provider. Often, individuals provide the websites with some or all of the items available for sale. Once items are sold, these individuals may also handle logistics associated with shipping or otherwise sending the physical items to buyers, such as buyers located in or outside of a state, region, or country where the seller is located.

### BRIEF DESCRIPTION OF THE DRAWINGS

The present technology is illustrated by way of example, and not by way or limitation, in the figures of the accompanying drawings.

FIG. 1 is a block diagram illustrating a network architecture of a system to determine shipping costs using a logistics table, in some example embodiments.

FIG. 2 is a block diagram illustrating a publication system of available products, in some example embodiments.

FIG. 3 is a schematic diagram illustrating an example logistics table.

FIG. 4 is a flow diagram illustrating a method for determining and presenting shipping costs for an item, in some example embodiments.

FIG. 5 is a display diagram illustrating an example user interface that displays shipping costs for an item to various destinations, in some example embodiments.

FIG. 6 shows a diagrammatic representation of a machine in the example form of a computer system within which a set of instructions may he executed to cause the machine to perform any one or more of the methodologies discussed herein.

### DETAILED DESCRIPTION

### Overview

Example methods and systems to determine shipping costs using a logistics table are described. In some example embodiments, the methods and systems access a base cost associated with shipping an item to a destination at a base level (e.g., standard shipping method), select one or more destinations to which to ship the item, and determine shipping costs for every selected destination by inputting the base cost into a logistics table. The systems and methods may also display an indication of the determined costs via a user interface, such as via a displayed map or other graphics that present shipping cost information along with destination information in an aggregated and/or simplified manner, among other things.

Thus, in some example embodiments, the methods and systems described herein enable sellers of products and other items over a network-based merchandising system to utilize a logistics table, such as a table that include entries relating shipping destinations to formulas that calculate costs to ship an item or items to the destinations, in order to easily determine and provide to buyers shipping costs associated with items purchased via the network-based merchandising system, among other benefits.

### Example Systems and Methods

In the following description, for purposes of explanation, numerous specific details are set forth in order to provide a thorough understanding of the present disclosure. It may be evident, however, to one skilled in the art that the subject. matter of the present disclosure may be practiced without these specific details.

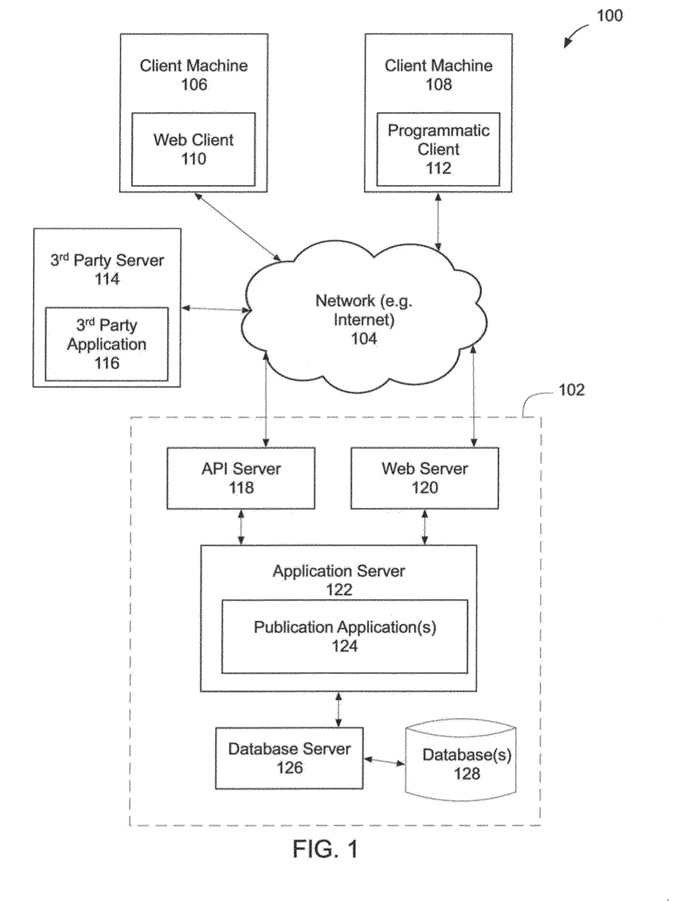

FIG. 1 is a block diagram illustrating a network architecture of a system to determine shipping costs using a logistics table, in some example embodiments. For example, the network system 100 may be or include a network-based publishing system 102 where clients may communicate and exchange data within the network system 100. The data may pertain to various functions (e.g., selling and purchasing of items) and aspects (e.g., data describing items listed on the network-based publishing system 102) associated with the network system 100 and its users. Although illustrated herein as a client-server architecture as an example, other example embodiments may include other network architectures, such as a peer-to-peer or distributed network environment.

A data exchange platform, in an example form of a network-based publishing system 102, may provide server-side functionality, via a network 104 (e.g., the Internet) to one or more clients. The one or more clients may include users that utilize the network system 100 and more specifically, the network-based publishing system 102, to exchange data over the network 104. These transactions may include transmitting, receiving (e.g., communicating), and processing data to from, and regarding content and users of the network system 100. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; influence data; and transaction data, among other things.

In various example embodiments, the data exchanges within the network system 100 may be dependent upon user-selected functions available through one or more client or user interfaces (UIs). The UIs may be associated with a client machine, such as a client machine 106 (e.g., client device) using a web client 110. The web client 110 may be in communication with the network-based publishing system 102 via a web server 120. The UIs may also be associated with a client machine 108 (e.g., client device) using a programmatic client 112, such as a client application, or a third party server 114 hosting a third party application 116. it can be appreciated in various example embodiments that the client device 106, 108, or third party server 114 may be associated with a buyer, a seller, a third party electronic commerce platform, a payment service provider, or a shipping service provider, each in communication with the network-based publishing system 102 and optionally each other. The buyers and sellers may he any one of individuals, merchants, or service providers, among other things.

Turning to the network-based publishing system 102, an application program interface (API) server 118 and the web server 120 are coupled to, and provide programmatic and web interfaces respectively to, one or more application servers 122. The application servers 122 host one or more publication application(s) 124. The application servers 122 are, in turn, shown to be coupled to one or more database server(s) 126 that facilitate access to one or more database(s) 128.

In some example embodiments, the web server 120 and the API server 118 communicate and receive data pertaining to listings, transactions, and feedback, among other things, via various user input tools. For example, the web server 120 may send and receive data to and from a toolbar or webpage on a browser application (e.g., web client 110) operating on a client machine (e.g., client device 106). The API server 118 may send and receive data to and from an application (e.g., programmatic client 112 or third party application 116) running on another client machine (e.g., client device 108 or third party server 114).

The publication application(s) 124 may provide a number of publisher functions and services (e.g., search, listing, payment, etc.) to users that access the network-based publishing system 102. For example, the publication application(s) 124 may provide a number of services and functions to users for listing goods and/or services for sale, providing shipping cost or other information associated with listed good and/or services, searching for goods and services, facilitating transactions, and reviewing and providing feedback about transactions and associated users. Additionally, the publication application(s) 124 may track and store data and metadata relating to listings, transactions, and user interactions with the network-based publishing system 102.

FIG. 1 also illustrates a third party application 116 that may execute on the third party server 114 and may have programmatic access to the network-based publishing system 102 via the programmatic interface provided by the API server 118. For example, the third party application 116 may use information retrieved from the network-based publishing system 102 to support one or more features or functions on a website hosted by the third party. The third party website may, for example, provide one or more listing, feedback, publisher, or payment functions that are supported by the relevant applications of the network-based publishing system 102.

While the example network system 100 of FIG. 1 employs a client-server architecture, a skilled artisan will recognize that the present disclosure is not limited to such an architecture. The example network system 100 can equally well find application in, for example, a distributed or peer-to-peer architecture system, among other things.

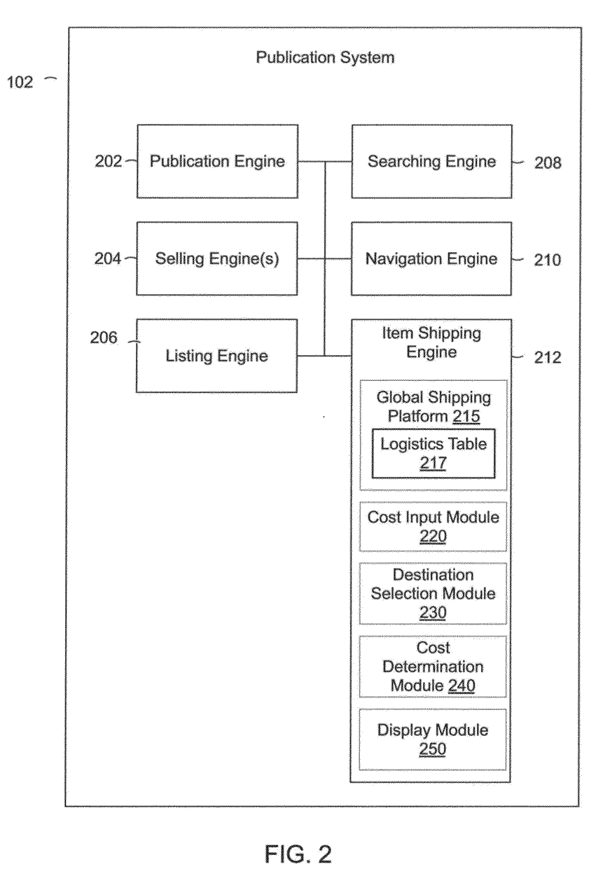

Referring now to FIG. 2, an example block diagram illustrating multiple components that, in some example embodiments, are provided within the network-based publishing system 102 of the network system 100 is shown. The network-based publishing system 102 may be hosted on dedicated or shared server machines (not shown) that are communicatively coupled to enable communications between the server machines. The multiple components, themselves, are communicatively coupled (e.g., via appropriate interfaces), either directly or indirectly, to each other and to various data sources, to allow information to be passed between the components or to allow the components to share and access common data. Furthermore, the components may access the one or more database(s) 128 via the one or more database servers 126, both shown in FIG. 1.

In some example embodiments, the publishing system 102 comprises a network-based marketplace and provides a number of publishing, listing, and price-setting mechanisms whereby a seller (e.g., business or consumer) may list (or publish information concerning) goods or services for sale, a buyer can search for, express interest in, or indicate a desire to purchase such goods or services, and a price can be set for a transaction pertaining to the goods or services. To this end, the publishing system 102 may comprise at least one publication engine 202 and one or more selling engines 204. The publication, engine 202 may publish information, such as item listings or product description pages, on the publishing system 102. In some example embodiments, the selling, engines 204 may comprise one or more auction engines that support auction-format listing and price setting mechanisms (e.g., English, Dutch, Chinese, Double, Reverse auctions, and so on). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may also include fixed price selling engines, among other things.

A listing engine 206 allows sellers to conveniently author listings of items or author publications. In some example embodiments, the listings pertain to goods or services that a user (e.g., a seller) wishes to transact via the publishing system 102. Each good or service is associated with a particular category. The listing engine 206 may receive listing data such as title, description, and aspect name/value pairs. Furthermore, each listing for a good or service may be assigned an item identifier. In some example embodiments, a user may create a listing that is an advertisement or other form of information publication. The listing information may then be stored to one or more storage devices coupled to the publishing system 102 (e.g., databases 128). Listings also may be comprised of product descriptions that display a product and information (e.g., product title, specifications, reviews, and so on) associated with the product. In some example embodiments, the product description page may include an aggregation of item listings that correspond to the product described on the product description page.

A searching engine 208 facilitates searching the network-based publishing system 102. For example, the searching engine 208 enables keyword queries of listings published via the publishing system 102. In some example embodiments, the searching engine 208 receives the keyword queries from a computing device associated with a user and conducts a review of the storage device storing the listing information. The review will enable compilation of a result set of listings that may be sorted and returned to the client device (e.g., client device 106) of the user. The searching engine 208 may record the query (e.g., keywords) and any subsequent user actions and behaviors (e.g., navigations).

A navigation engine 210 enables users to navigate through various categories, catalogs, or inventory data structures according to which listings may be classified within the publication engine 202. For example, the navigation engine 210 allows a user to successively navigate down a category tree comprising a hierarchy of categories until a particular set of listings is reached. Various other navigation applications within the navigation engine 210 may be provided to supplement the searching and browsing applications. The navigation engine 210 may record the various user actions (e.g., clicks) performed by the user in order to navigate down the category tree.

An item shipping engine 212 generates, provides, and/or utilizes a logistics table to determine costs associated with shipping items purchased from a seller over a network-based merchandising system to a buyer that purchased the items.

In some example embodiments, the item shipping engine 212 may include one or more modules and/or components to perform one or more operations of the item shipping engine 212. The modules may be hardware, software, or a combination of hardware and software, and may be executed by one or more processors. For example, the item shipping engine 212 may include a cost input module 220, a destination selection module 230, a cost determination module 240, and a display module 250.

In some example embodiments, the cost input module 220 is configured and/or programmed to access information identifying a base cost associated with shipping an item to a destination at a base level. A base cost may be a cost associated with shipping an item via a standard or base method or level of shipping, and may be a set or fixed rate for items of various sizes and/or weights.

A user, such as a seller of the item, may provide information identifying a base cost associated with shipping an item to a destination. For example, a seller associated with client device 106 or client device 108 may provide or enter information (e.g., a monetary amount) to the item shipping engine 212, may select one or more options displayed by the item shipping engine 212 that identify various base costs, and so on.

In some example embodiments, a destination selection module 230 is configured and/or programmed to select one or more destinations to which to ship the item. The destination selection module 230 may receive a selection from a seller via client device 106 or 108 of one or more destinations to which the seller may ship an item for sale. Example destinations may include countries (e.g., Australia or Canada), states (e.g., Hawaii or Wisconsin), regions (e.g., the European Union or Africa), and so on.

That is, in some example embodiments, the destination selection module 230 may select a destination that includes multiple geographical locations (e.g., all countries within the EU, all countries in Asia, and so on).

In order to facilitate the identification and/or selection of suitable or acceptable destination to which to ship items, the item shipping engine 212 may provide and/or access a platform, such as a global shipping platform (GSP) 215. For example, the GSP 215 may be a service that facilitates the sale of items to both domestic and international destinations by simplifying the steps to be performed by a seller when selecting shipping destinations. That is, the GSP 215 may receive from a seller information identifying a base cost associated with shipping an item from their location to a domestic warehouse associated with the publishing system 102 and/or the network-based merchandising system, and, using the base cost, determine shipping costs to other destinations, such as international destinations. In addition, the GSP 215 may include components that handle other formalities associated with shipping items to various destinations, such as customs forms, times, fees, tariffs, foreign trade restrictions, and so on.

In some example embodiments, the cost determination module 240 is configured and/or programmed to determine a shipping cost for some or all selected destinations by inputting a received and/or accessed base cost into a logistics table, such as logistics table 217. In some example embodiments, the item shipping engine 212, via the GSP 215 or other components, may generate, update, and/or navigate the logistics table 217, which may be a table or other data structure that includes one or more entries relating a shipping destination to a cost determination formula associated with shipping the item to the destination. In some example embodiments, the GSP 215 may determine the trade restrictions applicability for an item, and convey, via logistics table 217, such information for one or more particular regions.

The logistics table 217 may be a graphically supported data structure where region or destination specific information, expressed from a regional perspective (using any map or maps), may be pre-processed (e.g., compressed and stored in a renormalized form), enabling a quick retrieval of the information, among other things. In some example embodiments, the number of destination regions a seller may specify and/or select is approximately 300, although more or less are possible. Given such a large amount of selected regions, the logistics table 217 provides a generalization scheme to reduce the number of operations often required to determine shipping costs for each of the selected destinations. For example, the logistics table 217 provides such a scheme by providing one or more variables with a cost determination formula, such as a variable associated with the base cost of an item, a variable associated with a seller location, and/or a variable associated with a buyer location, among other things.

The logistics table 217 may also provide one or more entries that relate a group of destinations to a cost determination formula, enabling the logistics table 217 to pre-process information for many different destinations based on their affiliation and/or associated with a group of destinations. These groups may be predetermined (e.g., a geographical group of destinations within North America), be determined based on a seller's location (e.g., the USA, Mexico, and Canada may be grouped for a seller located in Asia, but would not grouped for a seller located in the USA), and/or may vary (e.g. a variable group of destinations based on current politics that identify destinations as “bad actors”), and so on.

An example cost determination formula to calculate the cost to ship an item to a destination or multiple destinations, such as to multiple international destinations, may be as follows:

Shipping Cost=BASE+GLOBAL_CALC(WHS-ZIP, ITEMDETAILS, DEST-ZIP),
where BASE=the base cost in dollars ($),
   WHS-ZIP=the zip code of a domestic warehouse,
   DEST-ZIP=the zip code of the shipping destination c.a., buyer location).
   ITEM-DETAILS=details associated with the item being shipped, such as size, weight, and so on, and
   GLOBAL_CALC=a predetermined algorithm to calculate the cost to ship the item from the domestic warehouse to the destination.

A user, such as a seller of the item, may provide information identifying a base cost associated with shipping an item to a destination, and/or the seller's location information. For example, a seller associated with client machine 106 or client machine 108 may provide or enter information (e.g., a monetary amount) to the listing constraint engine 212, may select one or more options displayed by the listing constraint engine 212 that identify various base costs, and so on. A base cost may be a cost associated with shipping an item via a standard or base method or level of shipping, and may be a set or fixed rate for items of various sizes and/or weights.

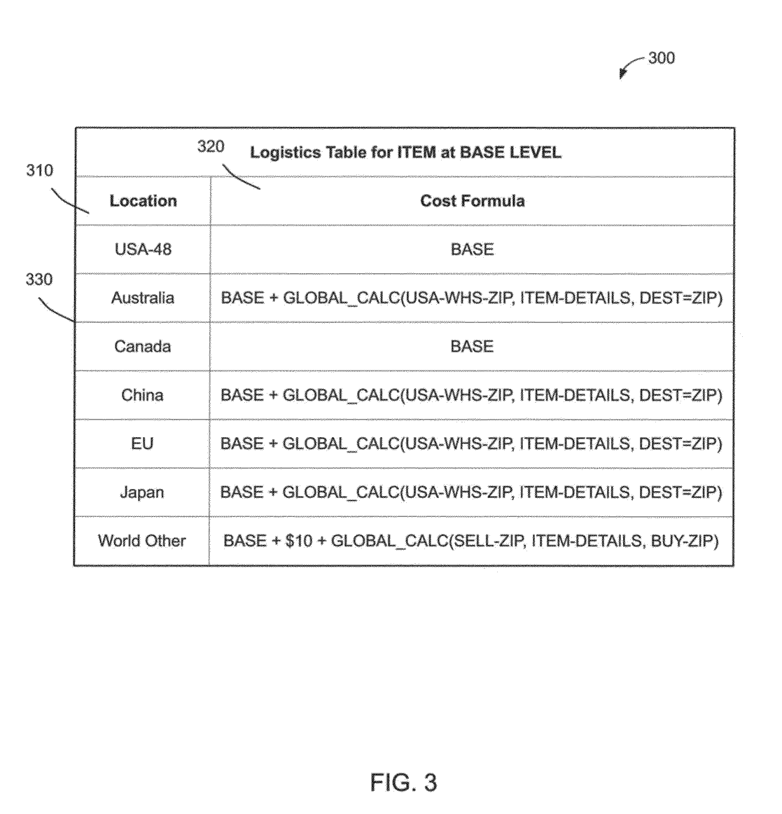

As described herein, the cost determination module 240 utilizes the logistics table 217 in order to determine the shipping costs to various domestic and/or international destinations associated with potential buyers of the item. FIG. 3 is a schematic diagram illustrating an example logistics table 300. The logistics table 300 includes various entries 330 that relate information associated with a shipping destination 310 to information associated with a cost formula 320, such as the cost determination formula described herein.

For example, the logistics table 300 may he generated for sellers located in the United States. The table 300 includes entries that relate a domestic shipping destination (e.g., USA-48) and various international shipping destinations (e.g., Australia, China, the EU, and so on) to associated cost formulas 320. The cost determination module 240, in determining shipping costs for shipping an item to various potential buyers, inputs a base cost into the logistics table 300, which calculates shipping costs for various destinations and returns the calculated costs to the cost determination module 240.

Of course, although the logistics table 300 presents certain destinations 310 and cost formulas 320, a suitable logistics table may include other destinations, formulas, and/or other information associated with determining shipping costs to various destinations. The logistics table 300 may include additional information that may be used to calculate costs associated with shipping an item using various shipping methods or within various timeframes. For example, the logistics table 300, in response to a received base cost, may calculate the cost to ship an item to various destinations using standard or base level methods of delivery, using expedited methods of delivery (e.g., overnight or 2-day timeframes), and so on.

Referring back to FIG. 2, in some example embodiments, the display module 250 is configured and/or programmed to display an indication of the determined shipping costs via a user interface or other display component. For example, the display module 250 may access shipping costs determined by the cost determination module 240, and render a map or other similar information graphic, such as a table, graph, chart, and so on, that presents visual indicators of costs to ship items to various destinations.

For example, using shipping costs determined by the cost determination module 240, the display module 250 may render and display a map that presents a base layer of geographical locations and an overlay of information associated with the determined shipping costs that includes two or more colors, wherein each color of the overlay represents a unique shipping cost indicator for an associated destination.

Although the various components of the publishing system 102 have been discussed in terms of a variety of individual modules and engines, one skilled in the art will recognize that many of the components can be combined or organized in other ways. Furthermore, not all components of the publishing system 102 have been included in FIG. 2. In general, components, protocols, structures, and techniques not directly related to functions of example embodiments (e.g., dispute resolution engine, loyalty promotion engine, reputation engines, listing management engines, account engine) have not been shown or discussed in detail. The description given herein simply provides a variety of example embodiments to aid the reader in an understanding of the systems and methods used herein.

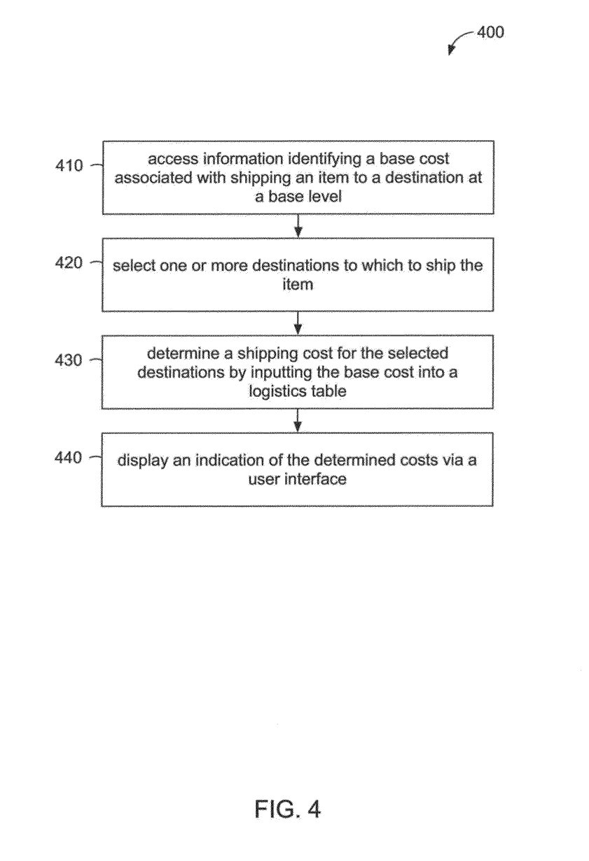

As described herein, the item shipping engine 212 may include modules or components configured to determine for a seller of an item, and/or display to the seller of the item, shipping costs to ship the item to potential buyers, such as users that purchase the item via a retail, auction site, and/or other network-based system, among other things. FIG. 4 is a flow diagram illustrating a method 400 for determining and presenting shipping costs for an item, in some example embodiments.

In operation 410, the item shipping engine 212 accesses information identifying a base cost associated with shipping an item to a destination at a base level. For example the cost input module 220 accesses a base cost to ship an item that is provided by a seller of the item, such as a base cost to ship the item to a domestic warehouse or other shipping facility associated with a network-based system through which the seller is selling the item.

In operation 420, the item shipping engine 212 selects one or more destinations to which to ship the item. For example, the destination selection module 230 receives a selection from a seller of various acceptable destinations to which to ship the item to potential buyers, such as domestic locations, international locations, international regions, groups of countries, and so on.

In operation 430, the item shipping engine 212 determines a shipping cost for the selected destinations by inputting the base cost into a logistics table. For example, the cost determination module 240 may determine a shipping cost for the selected destinations by inputting, a base cost or other information identifying a standard cost to ship the item into a table, such as table 300, that includes entries relating destinations to pricing formulas associated with shipping the item to the related destinations.

In operation 440, the item shipping engine 212 displays an indication of the determined costs via a user interface. For example, the display module 250 may render and/or display a map that includes information associated with the determined shipping costs that is displayed proximate to associated destinations presented by the map. The information associated with the shipping costs may be any type of visual indicator of the cost to ship the item to the associated destination.

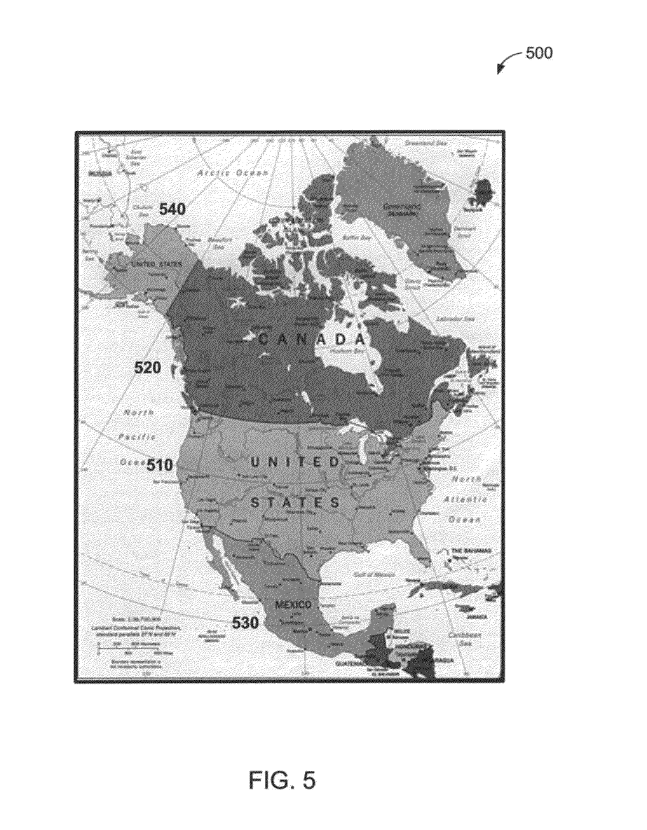

For example, the map may present an overlay of one or more colors that indicate the shipping costs to associated destinations. FIG. 5 is a display diagram illustrating an example user interface 500 that displays shipping costs for an item to various destinations, in some example embodiments. The user interface 500 depicts a map of North America, including a destination 510 associated with the mainland United States, a destination 520 associated with Canada, a destination 530 associated with Mexico, and a destination 540 associated with Alaska. The item shipping engine 212 may display various different colors to indicate different shipping costs to ship items to the various destinations 510-540.

As an example, the display module 250 may render and present the map of user interface 500 for a seller of an item that is located in England. The rendered map presents the destination 510 associated with the United States and the destination 520 associated with Canada with two different colors, indicating two different shipping rates to ship the item to buyers located at the destinations 510 or 520. In addition, the rendered map presents the destination 510 associated with the United States and the destination 530 associated with Mexico with the same color, indicating the same or similar shipping rates to ship the item to buyers located at the destinations 510 or 530. Thus, by rendering a map with variable colors, the display module 250 may provide a seller with a simple, instructive display of information that presents an aggregated view of the costs to ship an item to different destinations associated with potential buyers of the item, among other benefits.

Of course, the display module 250 may display other types of indicators to indicate variable shipping costs via a map or other graphic, such as icons or other graphical elements, text-based elements (e.g., the actual costs), different shades of the same color, lines or other markings, and so on.

Thus, in some example embodiments, the item shipping engine 212 enables a seller of an item to handle costs associated with the domestic shipping of items, while facilitating the determination and/or display of shipping costs for international destinations, among other things.

For example, a seller may utilize the item shipping engine 212 described herein to set up and provide a variety of different levels of service when selling items via a network-based system, such as an economy shipping level for domestic markets, an expedited shipping level for holiday and other time-sensitive sales, a flexible shipping level for all unknown or emerging markets, and so on. The item shipping engine 212, by utilizing the GSP 215 and/or the logistic tables 217 and 300 described herein, enable the seller to provide such a varied and diverse set of shipping options to potential buyers while shifting the complexity and burden to set up these shipping options from the seller to the network-based merchandising system supporting the sale of the seller's items, among other benefits.

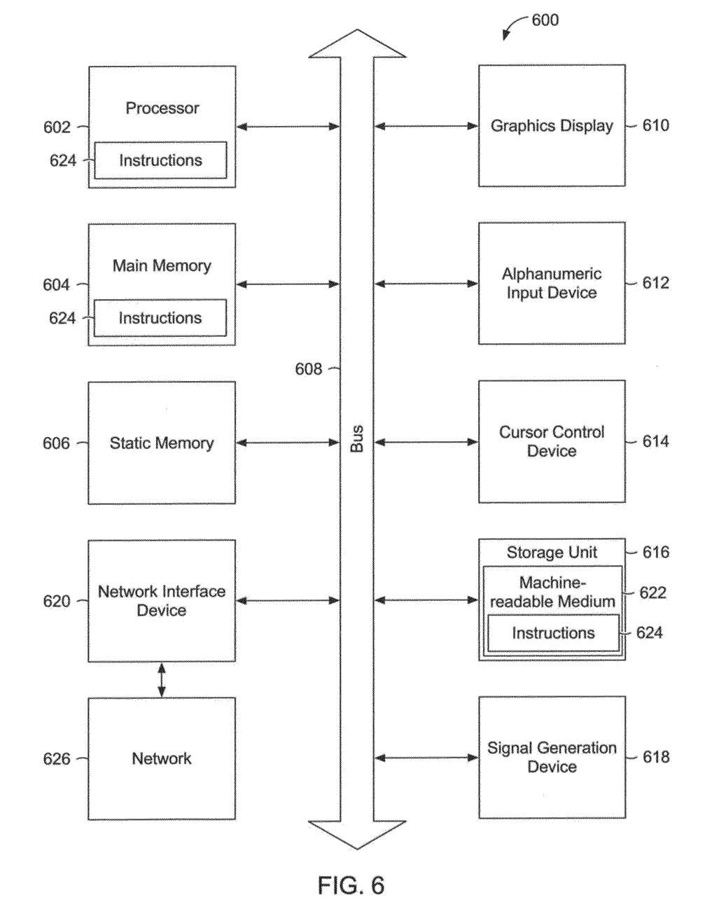

FIG. 6 shows a diagrammatic representation of machine in the exemplary form of a computer system 600 within which a set of instructions 624 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA) a cellular telephone, a web appliance, a network muter, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU) a graphics processing unit (GPU) or both), a main memory 604 and a static memory 606, which communicate with each other via a bus 608. The computer system 600 may further include a graphics display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a storage unit 616, a signal generation device 618 (e.g., a speaker) and a network interface device 620.

The storage unit 616 includes a machine-readable medium 622 on which is stored one or more sets of instructions 624 (e.g., software) embodying any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may further be transmitted or received over a network 626 via the network interface device 620.

While the machine-readable medium 622 is shown in an exemplary embodiment to be a single medium, the term “machine-readable medium” should be taken to include a single medium or multiple media (e.g., a centralized or distributed database, and/or associated caches and servers) that store the one or more sets of instructions 624. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly he taken to include, but not be limited to, solid-state memories, optical and magnetic media, and carrier wave signals.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated, at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

Although the present disclosure has been described with reference to specific exemplary embodiments, it may be evident that various modifications and changes may be made to these embodiments without departing from the broader spirit and scope of the disclosure. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to he taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description.

In this document, the terms “a” or “an” are used, as is common in patent documents, to include one or more than one. in this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

What is claimed is:

1. A system, comprising:
a cost input module that is configured to access information identifying a base cost associated with shipping an item to a destination at a base level;
a destination selection module that is configured to select one or more destinations to which to ship the item;
a cost determination module that is configured to determine a shipping cost for the selected one or more destinations by inputting the base cost into a logistics table; and
a display module that is configured to display an indication of the determined costs via a user interface.

2. The system of claim 1 wherein the display module is configured to display a map that includes visual indicators associated with the determined shipping costs for the selected destinations.

3. The system of claim 1 wherein the display module is configured to display a map that displays a base layer of possible destinations as geographical locations and an overlay of information associated with the determined, shipping costs that includes two or more colors, wherein each color of the overlay represents a unique shipping cost for an associated destination.

4. The system of claim 1, wherein the display module is configured to display a table that includes information that relates the selected destinations with the determined shipping costs.

5. The system of claim 1, wherein the destination selection module is configured to receive a selection of a destination that includes multiple geographical locations.

6. The system of claim 1, wherein the cost determination module is configured to input the base cost into one or more entries of the logistics table in order to determine shipping costs for the selected destinations, wherein each of the one or more entries relates a selected location to a cost determination formula associates with shipping the time item to the destination.

7. The system of claim 1, wherein the cost input module is configured to access the base cost associated with shipping the item to the destination at the base level, a a time period in which to ship the item to the destination, and a location associated with a seller of the item, from a logistics table that relates the destination to a cost determination formula to ship the item to the destination; and
wherein the cost determination module is configured to determine the shipping cost for every selected destination using the logistics table.

8. A computer-implemented method, comprising:
accessing information identifying a base cost associated with shipping an item to a destination at a base level;
selecting one or more destinations to which to ship the item;
determining a shipping cost for the one or more selected destinations by inputting the base cost into a logistics table; and
displaying an indication of the determined costs via a user interface.

9. The computer-implemented method of claim 8, wherein determining a shipping cost for the one or more selected destinations by inputting the base cost into a logistics table includes inputting the base cost into a logistics table that relates destinations to pricing formulas associated with shipping the item to the related destinations.

10. The computer-implemented method of claim 8, wherein displaying an indication of the determined costs includes displaying a map that includes information associated with the determined shipping costs that is displayed proximate to associated destinations presented by the map.

11. The computer-implemented method of claim 8, wherein displaying an indication of the determined costs includes displaying a map that displays a base layer of possible destinations as geographical locations and an overlay of information associated with the determined shipping costs that includes two or more colors, wherein each color of the overlay represents a unique shipping cost for an associated destination.

12. The computer-implemented method of claim 8, wherein receiving a selection of one or more acceptable destinations to which to ship the item includes receiving a selection of a destination that includes multiple geographical locations.

13. The computer-implemented method of claim 8, wherein accessing a base cost associated with shipping an item to a destination at a base level includes accessing the base cost associated with shipping the item to the destination at the base level and accessing a time period in which to ship the item to the destination; and
wherein determining a shipping cost for the one or more selected destinations by inputting the base cost into a logistics table includes determining the shipping cost for every selected destination using the logistics table and the time period in which to ship the item to the destination.

14. A computer-readable storage medium whose contents, when executed by a computing system, cause the computing system to perform operations, comprising:
accessing a base cost associated with shipping an item to a destination at a base level;
selecting one or more destinations to which to ship the item;
determining a shipping cost for the one or more selected destinations by inputting the base cost into a logistics table; and
displaying an indication of the determined costs via a user interface.

15. The computer-readable storage medium claim 14, wherein determining a shipping cost for every the one or more selected destinations by inputting the base cost into a logistics table includes inputting the base cost into a logistics table that relates destinations to pricing formulas associated with shipping the item to the related destinations.

16. The computer-readable storage medium claim 14, wherein displaying an indication of the determined costs includes displaying a map that includes information associated with the determined shipping costs that is displayed proximate to associated destinations presented by the map.

17. The computer-readable storage medium claim 14, wherein displaying an indication of the determined costs includes displaying a map that displays a base layer of possible destinations as geographical locations and an overlay of information associated with the determined shipping costs that includes two or more colors, wherein each color of the overlay represents a unique shipping cost for an associated destination.

18. The computer-readable storage medium claim 14, wherein receiving a selection of one or more destinations to which to ship the item includes receiving a selection of a destination that includes multiple geographical locations.

19. The computer-readable storage medium claim 14, wherein accessing a base cost associated with shipping an item to a destination at a base level includes accessing the base cost associated with shipping the item to the destination at the base level and accessing a time period in which to ship the item to the destination; and
wherein determining a shipping cost for the one or more selected destinations by inputting the base cost into a logistics table includes determining the shipping cost for every selected destination using the logistics table and the time period in which to ship the item to the destination.

20. The computer-readable storage medium claim 14, wherein the logistics table is a data structure that relates multiple destinations to which to ship items to pricing formulas associated with shipping items to the related destinations, and wherein the pricing formulas calculate costs to ship items to destinations based on a single variable input for the pricing formulas that is associated with a base cost to ship an item to a destination.
